(19) United States
(12) Patent Application Publication
(10) Pub. No.: US 2013/0095832 A1
(43) Pub. Date: Apr. 18, 2013

(54) METHOD AND APPARATUS FOR MEASURING CELLS IN AN IDLE OR SLEEP MODE

(71) Applicants: Steven D. Cheng, San Diego, CA (US); Tom Chin, San Diego, CA (US); Guangming Shi, San Diego, CA (US); Kuo-Chun Lee, San Diego, CA (US)

(72) Inventors: Steven D. Cheng, San Diego, CA (US); Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/272,184

(22) Filed: Oct. 12, 2011

(51) Int. Cl. H04W 36/00

(52) U.S. Cl. 455/436

(57) ABSTRACT

Methods and apparatuses are provided for communicating with multiple base stations in idle or sleep mode communications. During such modes, antennas or related resources of a device can be assigned for receiving signals from a source base station, such as paging or similar signals, or for measuring other base stations. The resource assignment can be determined based on the mode or a related time interval, one or more additional factors, such as a signal quality at the source base station, and/or the like.

### BACKGROUND

1. Field

The following description relates generally to wireless network communications, and more particularly to measuring neighboring cells.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as Worldwide Interoperability for Microwave Access (WiMAX, IEEE 802.16), third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

In addition, in some wireless communication technologies, such as WiMAX, LTE, etc., devices can perform measurements of base stations other than a source or serving base station to determine when communications are improved at the other base stations. This information can be used for mobility at the device (e.g., to cause the device to handover communications to the other base stations). Moreover, some wireless communication technologies allow devices to communicate in an idle mode, during which the devices enter a power saving mode effectively hibernating radio activity, except for retaining functionality to receive paging signals that can cause the device to resume radio connectivity.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with measuring cells for mobility or other purposes during idle or sleep mode communications. For example, a device can determine whether to measure cells for mobility, which antennas or other resources to utilize for measuring the cells, and/or the like based at least in part on the mode. In one example, the device can determine whether to utilize multiple-input multiple-output (MIMO) antennas for measuring other cells, whether to reserve the MIMO antennas for communicating with a source base station, whether to use a portion of the MIMO antennas (e.g., in single-input single-output (SISO) or otherwise) to measure other cells, etc. based on the mode. The device can also consider one or more measurements of the source base station in determining the above.

According to an example, a method for wireless communication is provided that includes communicating with a source base station using at least one of a plurality of antennas and determining a switch in a communication mode with the source base station. The method further includes assigning at least another one of the plurality of antennas for communicating with a different base station while in the communication mode.

In another aspect, an apparatus for wireless communication is provided. The apparatus includes at least one processor configured to communicate with a source base station using at least one of a plurality of antennas and determine a switch in a communication mode with the source base station. The at least one processor is further configured to assign at least another one of the plurality of antennas for communicating with a different base station while in the communication mode. The apparatus also includes a memory coupled to the at least one processor.

In yet another aspect, an apparatus for wireless communications is provided that includes means for communicating with a source base station using at least one of a plurality of antennas and means for determining a switch in a communication mode with the source base station. The apparatus further includes means for assigning at least another one of the plurality of antennas for communicating with a different base station while in the communication mode.

Still, in another aspect, a computer-program product is provided including a computer-readable medium having code for causing at least one computer to communicate with a source base station using at least one of a plurality of antennas and code for causing the at least one computer to determine a switch in a communication mode with the source base station. The computer-readable medium further includes code for causing the at least one computer to assign at least another one of the plurality of antennas for communicating with a different base station while in the communication mode.

Moreover, in an aspect, an apparatus for wireless communications is provided that includes a mode determining component for determining a switch in a communication mode with a source base station. The apparatus further includes a resource assigning component for assigning at least one of a plurality of antennas for communicating with a different base station while in the communication mode and keeping at least another one of the plurality of antennas reserved for communicating with the source base station while in the communication mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example wireless communication system, in accordance with certain embodiments of the present disclosure.

FIG. 2 illustrates various components that can be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates a block diagram of an example system for communicating with multiple base stations over multiple antennas.

FIG. 5 illustrates a block diagram of an example system for assigning resources for communicating with multiple base stations in idle or sleep mode communications.

FIG. 6 illustrates example timelines for communicating with one or more base stations in an available or unavailable time period.

FIG. 7 illustrates example timelines for performing cell measurements in unavailable time intervals.

FIG. 8 illustrates example timelines for performing received signal strength indicator (RSSI)-type cell measurements in unavailable time intervals.

FIG. 9 illustrates example timelines for performing RSSI-type cell measurements in unavailable time intervals and using single-input single-output (SISO) to communicate with a source base station.

FIG. 10 illustrates example timelines for performing carrier to interference and noise ratio (CINR)-type cell measurements in unavailable time intervals.

FIG. 11 illustrates example timelines for performing CINR-type cell measurements in unavailable time intervals and using SISO to communicate with a source base station.

FIG. 12 illustrates example timelines for performing RSSI-type cell measurements in unavailable time intervals.

FIG. 13 illustrates example timelines for performing CINR-type cell measurements in unavailable time intervals.

FIG. 14 illustrates example timelines for performing cell measurements in available time intervals.

FIG. 15 illustrates example timelines for performing cell measurements in available and unavailable time intervals.

FIG. 16 illustrates example timelines for performing cell measurements using a second antenna of a mobile station (MS).

FIG. 17 illustrates example timelines for performing cell measurements in unavailable time intervals using a first antenna of an MS and during available and unavailable time intervals using a second antenna of the MS.

FIG. 18 illustrates example timelines for performing cell measurements during downlink subframes corresponding to an available time interval.

FIG. 19 is a flow chart of an aspect of a methodology for assigning resources in idle or sleep mode communications.

FIG. 20 is a flow chart of an aspect of a methodology for assigning resources for communicating with multiple base stations in idle or sleep mode communications based on a signal quality measurement of the source base station.

FIG. 21 is a block diagram of an aspect of a system that assigns resources in idle or sleep mode communications.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a device operating in idle mode or sleep mode can determine antennas or other resources to utilize for performing measurements of other cells for mobility or other purposes. For example, when operating in an unavailable time period in a sleep or idle mode, or other mode where a source base station does not require resources from the device, the device can utilize substantially all available antennas to perform intra- or inter-frequency measurements of one or more cells. Where the device is operating in an available time period of a sleep or idle mode or another period where the source base station may require at least minimal antennas for receiving paging signals, the device can utilize a portion of antennas to measuring other cells. In an example, the device can determine antennas for measuring other cells based additionally on a measurement of the source base station. Thus, for example, where a signal measurement of the source base station is over a threshold level, the device can keep at least some minimal resources (e.g., a single antenna) for receiving paging signals from the source base station, as compared to where the signal measurement is weak. Where the signal measurement is below a threshold level indicating handover, however, multiple or all resources can be utilized to measure other base stations. This allows for efficient cell measurement over the resources.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

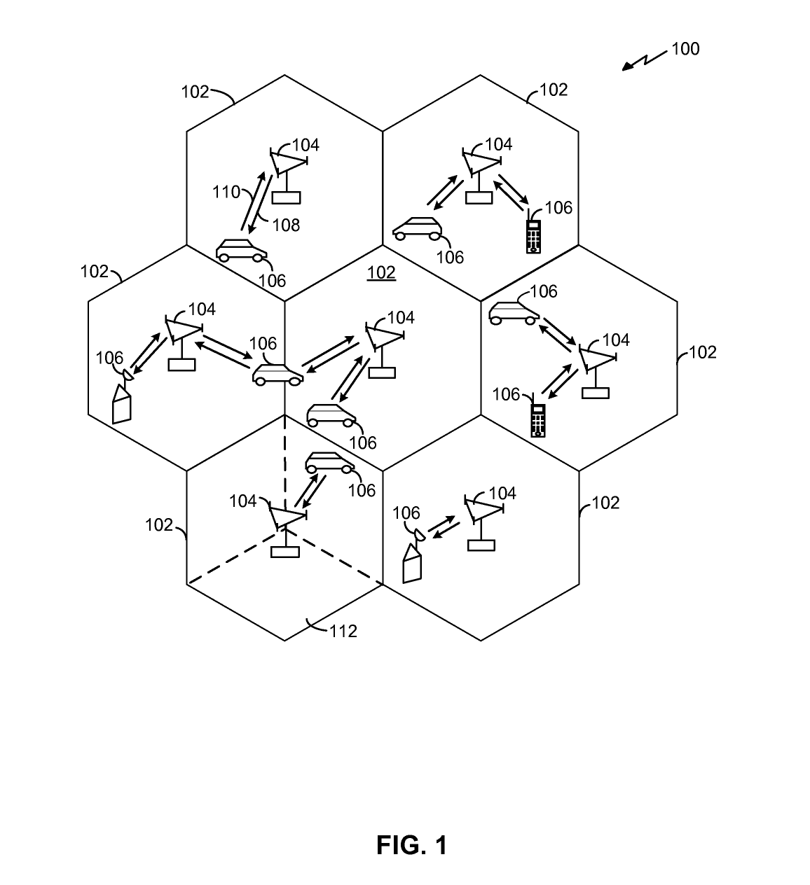

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (e.g., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

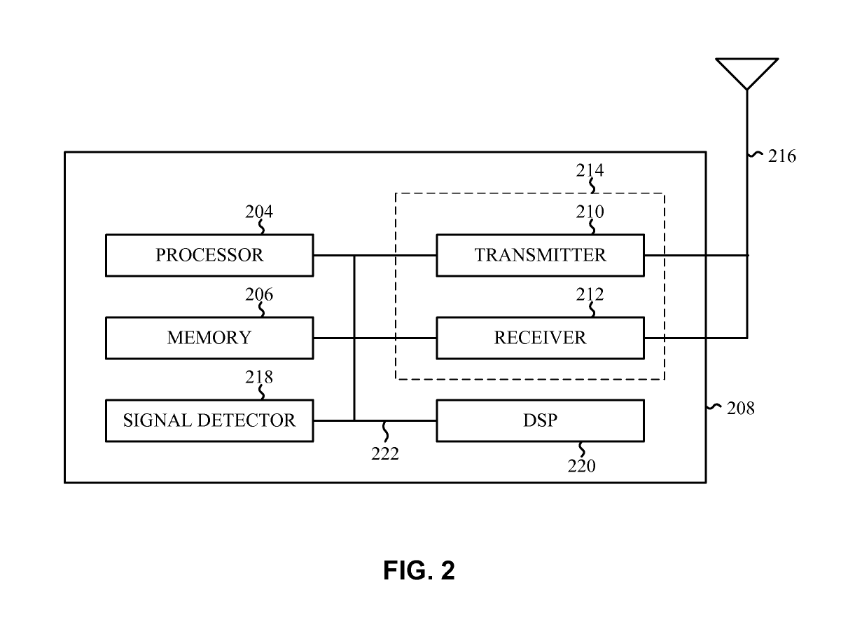

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas to facilitate MIMO communications.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

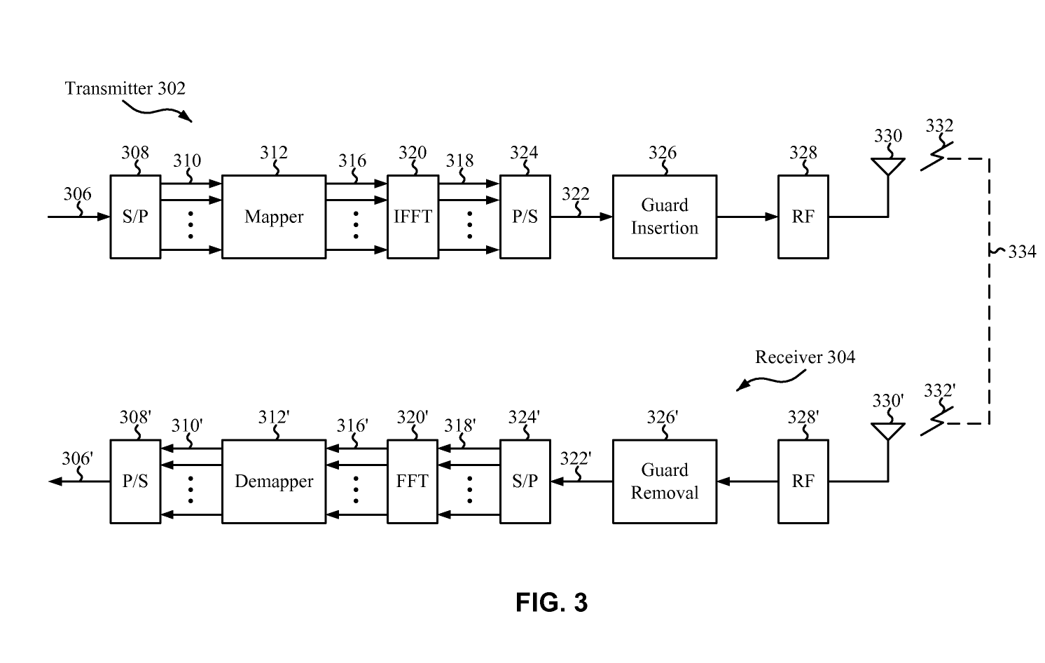

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, N.sub.s, is equal to N.sub.cp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found in a baseband processor.

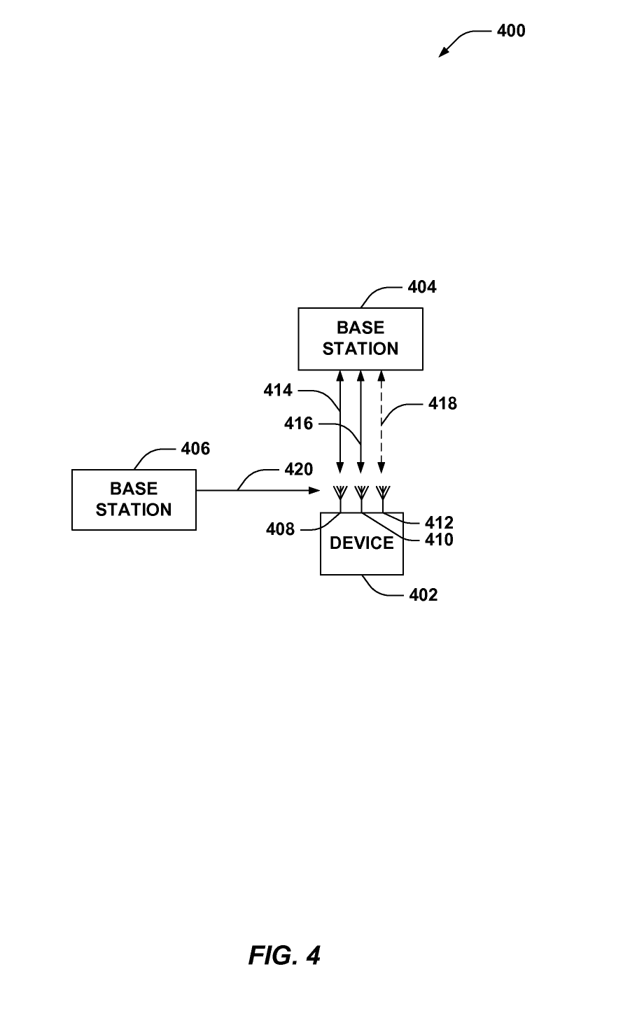

Referring to FIG. 4, a wireless communication system 400 is illustrated that facilitates allocating MIMO resources during sleep or idle mode communications. System 400 can include a device 402 that communicates with one or more base stations 404 and/or 406 to receive wireless network access. For example, device 402 can include multiple antennas 408, 410, and 412 for communicating in MIMO with the one or more base stations 404 and/or 406. It is to be appreciated that antennas 408, 410, and 412 can be separate physical antennas at device 402, one or more virtual antenna ports that operate over a lesser number of antennas (e.g., or a greater number where physical antennas are combined to produce a single antenna port), and/or the like. Moreover, for example, the antennas 408, 410, and 412 can correspond to assigned MIMO resources over one or more physical antennas. In addition, though three antennas or related resources are shown, it is to be appreciated that substantially any number of antennas or resources can be utilized for MIMO communications and for aspects described herein.

In an example, device 402 can be a UE, modem (or other tethered device), a portion thereof, and/or the like. Base stations 404 and 406 can each be a macrocell, femtocell, picocell, mobile, or other base station, a relay node, a UE (e.g., communicating in peer-to-peer or ad-hoc mode with device 402), a portion thereof, and/or the like. Moreover, the base stations 404 and 406 can be of different radio access technologies (RAT), in one example.

According to an example, device 402 can communicate with base station 404 over the multiple antennas 408, 410, and 412 or related MIMO resources. As depicted, for example, device 402 can communicate signals 414 and 416 over antennas 408 and 410, and optionally communicate signals 418 to base station 404 over antenna 412. In one example, device 402 can transition to idle or sleep mode communications with base station 404. For example, the base station 404 can command the device 402 to enter the idle or sleep mode, or the device 402 can otherwise determine to enter the idle or sleep mode based on detecting a period of inactivity with base station 404, etc. Based at least in part on entering the idle or sleep mode, the device 402 can determine whether a portion of antennas 408, 410, 412, and/or related resources can be used to measure signals from other base stations or related cells for mobility or other purposes.

For example, where the device 402 enters an available interval during the idle or sleep mode, the device 402 can determine to utilize at least a portion of the resources for receiving paging or other signals from base station 404, such as at least one of antennas 408 or 410 that can receive signals. In one example, the portion of the resources can be determined based at least in part on one or more measurements corresponding to base station 404. For example, where a signal quality measurement of base station 404 is under a threshold signal quality, device 402 can determine to keep multiple resources (e.g., antennas 408 and 410) available for receiving signals from base station 404 during the available interval. If other resources remain (e.g., antenna 412), device 402 can use these resources for measuring signals of other base stations or related cells, such as base station 406. In another example, device 402 can determine to assign multiple resources (e.g., antennas 408, 410, and 412) for measuring signals from the other base stations where the signal quality of base station 404 is below a minimum threshold (e.g., a handover threshold).

Where the signal quality measurement is over a threshold level, device 402 can determine to keep at least minimum resources (e.g., antenna 408) available for receiving signals from base station 404 during the available interval, while other resources (e.g., antennas 410 and 412) can be utilized for performing intra- or inter-frequency measurements of one or more base station 406. In this example, antennas 410 and/or 412 can be utilized to receive signals 420 from base station 406 for measurement. In other examples, during unavailable intervals where device 402 is in idle or sleep mode, the device 402 can determine to utilize substantially all resources (e.g., antennas 408, 410 and 412) to measure other base stations or related cells since base station 404 does not transmit to device 402 during such intervals. It is to be appreciated, however, that by efficiently using resources in available time intervals, as described, the device 402 can save additional power by refraining from performing unnecessary measurements during unavailable time intervals.

In either case, device 402 can utilize the signal measurements for one or more purposes, such as to perform mobility procedures. Moreover, as described further herein, the device 402 can select a measurement type based one or more factors to further conserve power. The device 402 can perform carrier to interference and noise ratio (CINR), received signal strength indicator (RSSI), or similar measurements based on a length of time or remaining available time associated with the mode or interval, based on whether the base stations to measure operate on a different frequency from the source base station, based on one or more power consumption parameters, based on the signal quality of the source base station, and/or the like.

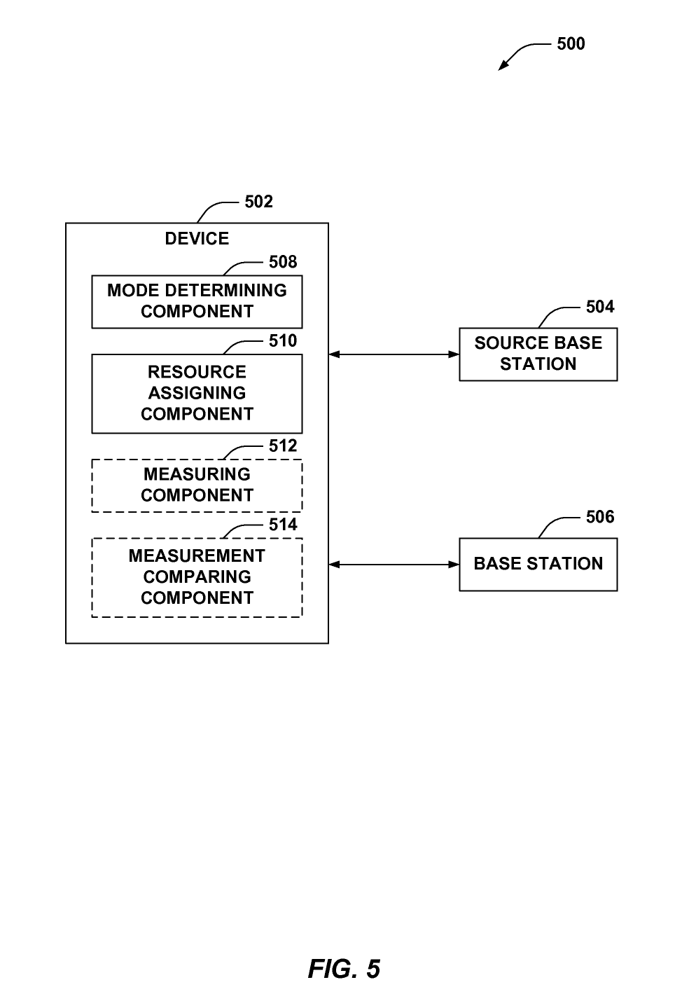

Turning to FIG. 5, an example system 500 is illustrated for determining MIMO resource assignments during an idle or sleep mode in wireless communications. System 500 includes a device 502 that communicates with a source base station 504 to receive access to a wireless network, and/or one or more other base stations, such as base station 506, in certain communication modes or related time intervals. As described, device 502 can communicate with source base station 504 using multiple physical or virtual antennas in a MIMO configuration to increase communication throughput, receive additional services, and/or the like. Moreover, as described, device 502 can be a UE, modem, etc., and source base station 504 and base station 506 can each be a macrocell, femtocell, picocell, or similar base station, a mobile base station, etc.

Device 502 can include a mode determining component 508 for determining a communication mode or related interval of the device 502 and/or of a source base station, and a resource assigning component 510 for allocating MIMO resources to the source base station or another base station based on the communication mode or related interval thereof. Device 502 can also optionally include a measuring component 512 for measuring signals from the source base station, and a measurement comparing component 514 for evaluating the signal measurements against one or more thresholds.

According to an example, mode determining component 508 can detect a change in communication mode between the device 502 and source base station 504, or otherwise determine a current communication mode (e.g., based on a request from one or more components of device 502). For example, this can be based on a timer (e.g., used to detect a period of inactivity), receiving one or more events or other indicators from source base station 504, such as a start of the mode or a related time interval, and/or the like. The change can correspond to switching from an active communication mode to an idle or sleep mode, switching among time intervals within a communication mode (e.g., an available or unavailable time interval in idle or sleep mode), etc. Resource assigning component 510, in an example, can reassign MIMO resources (e.g., which can correspond to a plurality of physical or virtual antennas) previously used to communicate with source base station 504 for another purpose, such as to measure signals from one or more base stations (e.g., base station 506) operating on a similar or different frequency based at least in part on the change in communication mode.

For instance, where mode determining component 508 determines the device 502 is communicating in an unavailable time interval of a sleep or idle mode, resource assigning component 510 can assign substantially all MIMO resources of device 502 for receiving signals from other base stations, such as base station 506, during the unavailable time interval. In one example, however, though substantially all of the MIMO resources can be available, resource assigning component 510 may not assign all the MIMO resources for measuring one or more base stations to conserve power at device 502.

Where mode determining component 508 determines a switch in communication mode, resource assigning component 510 can reassign at least some of the MIMO resources for communicating with source base station 504. For example, where mode determining component 508 determines a switch to an available time interval, resource assigning component 510 can assign at least one resource for receiving paging signals or other information from source base station 504 during the time interval. In another example, where mode determining component 508 determines a switch to an active communication mode, resource assigning component 510 can reassign substantially all resources for communicating with source base station 504.

In addition, for example, resource assigning component 510 can determine a number of resources for assigning to source base station 504 and/or for measuring other base stations based at least in part on one or more parameters, such as a signal quality of source base station 504. Thus, if the signal quality is low, resource assigning component 510 can assign more than a single resource for receiving signals from source base station 504 in an available time period in idle or sleep mode, for example, to improve likelihood of successfully receiving and processing a paging signal from the source base station 504. In this example, measuring component 512 can be utilized to obtain one or more measurements of source base station 504, such as a signal quality measurement (e.g., CINR, RSSI, or similar measurements). Measurement comparing component 514 can compare the signal quality measurement to one or more thresholds, and resource assigning component 510 can evaluate the comparison in determining a number of resources to assign to source base station 504.

In one example, measurement comparing component 514 can additionally or alternatively compare the signal quality measurement to a value used to determine whether to handover device 502 from source base station 504 (e.g., a downlink channel descriptor (DCD) handover value in WiMAX). Where the signal quality measurement is below the handover value when device 502 is communicating in an idle or sleep mode (e.g., during an available time interval), for example, resource assigning component 510 can assign MIMO resources for receiving signals from other base stations, such as base station 506. Where the signal quality measurement is above the handover value, resource assigning component 510 can reserve at least a single resource for listening for paging signals from source base station 504 or otherwise communicating therewith in SISO while assigning a remaining portion of the resources for measuring other base stations in MIMO. It is to be appreciated that where enough resources exist for allowing MIMO for both purposes, resource assigning component 510 can similarly assign the resources as a function of the signal quality measurement, which may include MIMO assignments for each purpose.

In another example, resource assigning component 510 can reserve additional resources for listening for paging signals from source base station 504 while assigning a single resource for measuring other base stations, etc., which can be based on the signal quality measurement of the source base station 504. In any case, measuring component 512 can be used for measuring other base stations, such as base station 506. In one example, measuring component 512 can determine which type of measurement to perform for the other base stations based on one or more parameters, such as a length of the communication mode or related interval or a remaining time available, one or more power consumption parameters, whether the other base stations operate on a similar or different frequency as the source base station, and/or the like. For example, measuring component 512 can determine to perform an RSSI measurement, as opposed to a CINR measurement, of one or more of the other base stations where the amount of time available is below a threshold level, where less power consumption is desired, where the other base stations operate on a different frequency, and/or the like.

Described further herein are various example scenarios for assigning MIMO resources (e.g., antennas) in various time intervals of idle and sleep modes in WiMAX. As described generally above, it is to be appreciated that the concepts are applicable to substantially any wireless technology that utilizes active and idle (and/or sleep) communication modes to conserve power at a device.

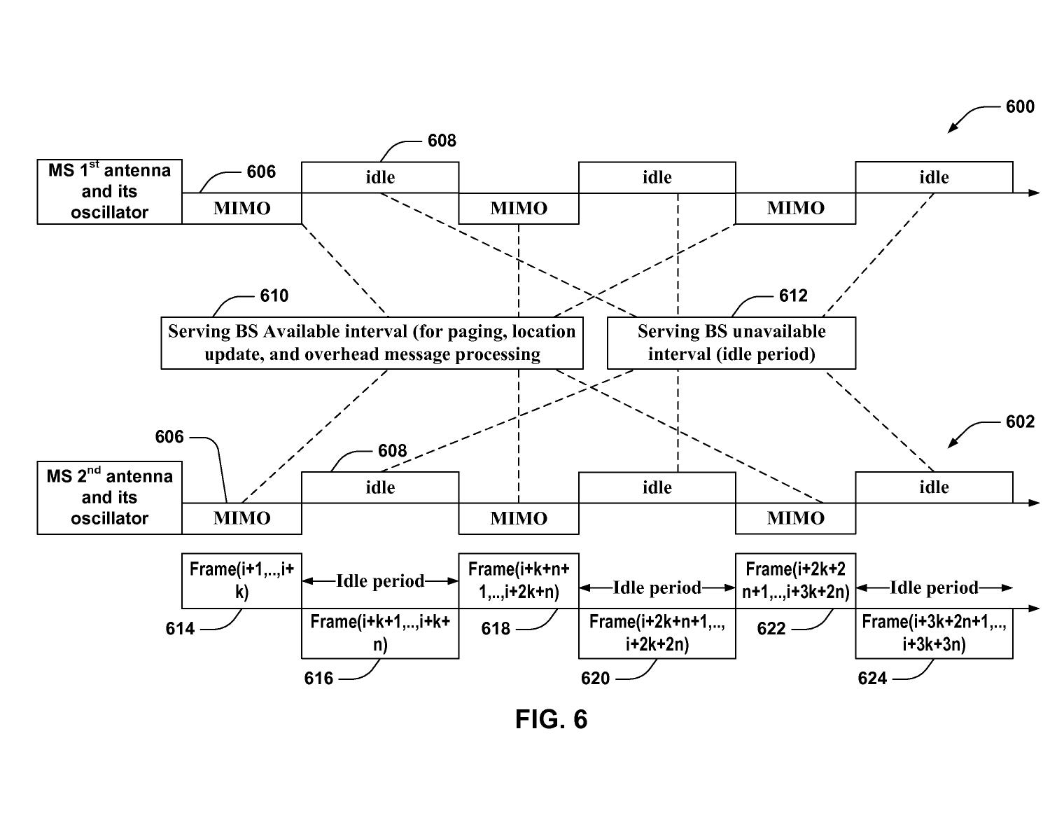

FIG. 6 illustrates example communication timelines 600 and 602 in WiMAX showing available and unavailable time intervals inside an idle mode. Timeline 600 corresponds to a first antenna at a mobile station (MS) (e.g., and its oscillator), and timeline 602 corresponds to a similar timeline for a second antenna at the MS (e.g., and its oscillator). Timelines 600 and 602 each include alternating MIMO periods 606, where MIMO resources are configured to possibly receive signals from a base station (BS) and idle periods 608. For example, the MIMO periods 606 can correspond to an available time interval 610, and the idle periods 608 can correspond to unavailable time intervals 612. As described, available time intervals 610 can correspond to time intervals during which the MS may receive certain signals from a BS, such as paging, location update, or other overhead messages, and thus MIMO resources are allocated for this purpose. Unavailable time intervals 612 can correspond to time intervals during which the BS does not transmit signals to the MS. The resources used during the intervals can be defined according to a preconfiguration at the MS, a configuration received from the BS, and/or the like. Based on the interval configuration, as described above and further herein, MS can determine resource assignments for receiving signals from a source base station and/or measuring other base stations during idle mode.

In addition, for example, the time intervals can be defined by a number of frames. For example, the available time interval for MIMO periods 606 can be defined as frames i+1 to i+k, where i is an initial frame index, and k is the number of frames of the available time interval, shown at 614. The next unavailable time interval for idle periods 608 can then be defined as frames i+k+1 to i+k+n, where n is the number of frames of the unavailable time interval, shown at 616. The following available time interval can then be defined as frames i+k+n+1 to i+2k+n, as shown at 618. The following unavailable time interval can then be defined as frames i+2k+n+1 to i+2k+2n, as shown at 620. The following available time interval can then be defined as frames i+2k+2n+1 to i+3k+2n, as shown at 622. The following available time interval can then be defined as frames i+3k+2n+1 to i+3k+3n, as shown at 624, and so on.

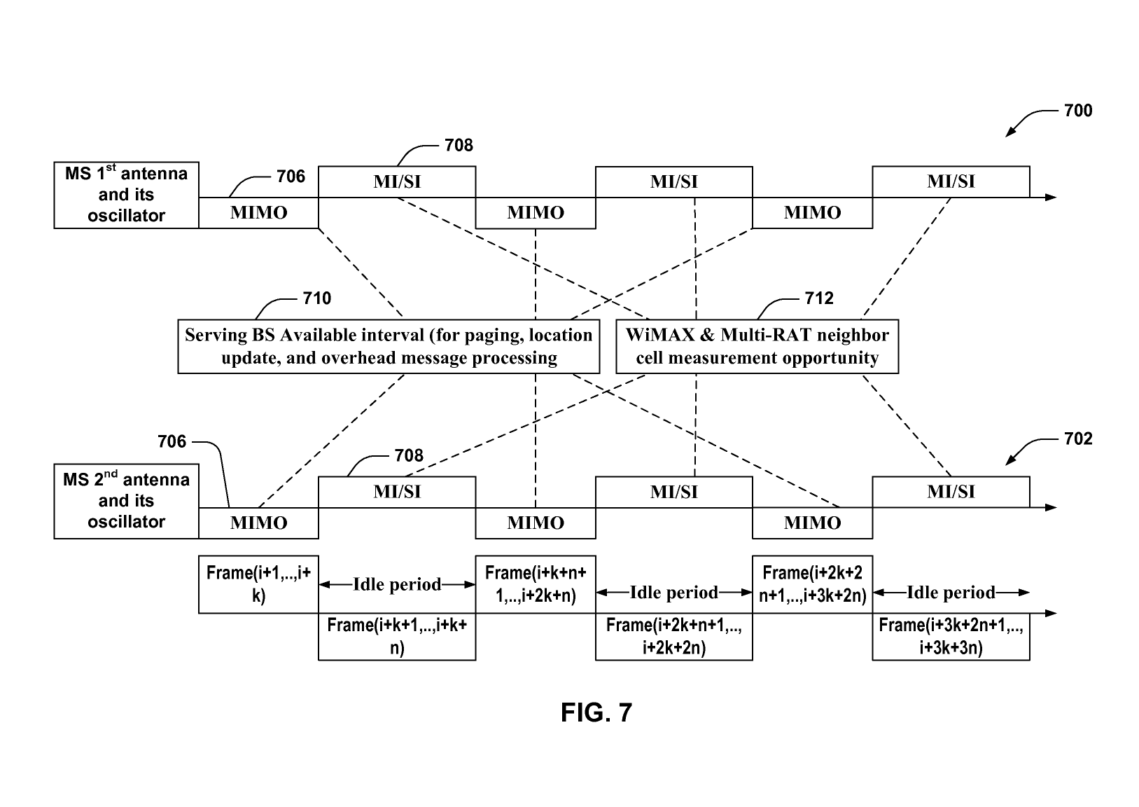

FIG. 7 illustrates example communication timelines 700 and 702 in WiMAX where idle mode unavailable time intervals can be used for performing measurements of other base stations. Timeline 700 corresponds to a first antenna at a mobile station (MS), and timeline 702 corresponds to a similar timeline for a second antenna at the MS. Timelines 700 and 702 each include alternating MIMO periods 706 and multiple input (MI) or single input (SI) periods 708, where the MS can receive signals using multiple or single resources, as described. Thus, during the MIMO periods 706 relating to available time intervals 710, the MS can utilize the MIMO resources for listening for paging or other signals from the base station. During MI/SI periods 708 relating to unavailable time intervals 712, the MS can measure WiMAX base stations or base stations of another RAT (e.g., on the same or another frequency) using a single resource (e.g., SI) or multiple resources (e.g., MI). The resources used during the intervals can be defined according to a preconfiguration at the MS, a configuration received from the BS, and/or the like. For example, as described, multiple or single resources can be assigned in periods 708 for measuring signals of other base stations based further on a signal quality of a source base station (e.g., where the CINR is greater than a DCD handover value). Moreover, it is to be appreciated that the available and unavailable time intervals can be defined according to a number of frames, as described above.

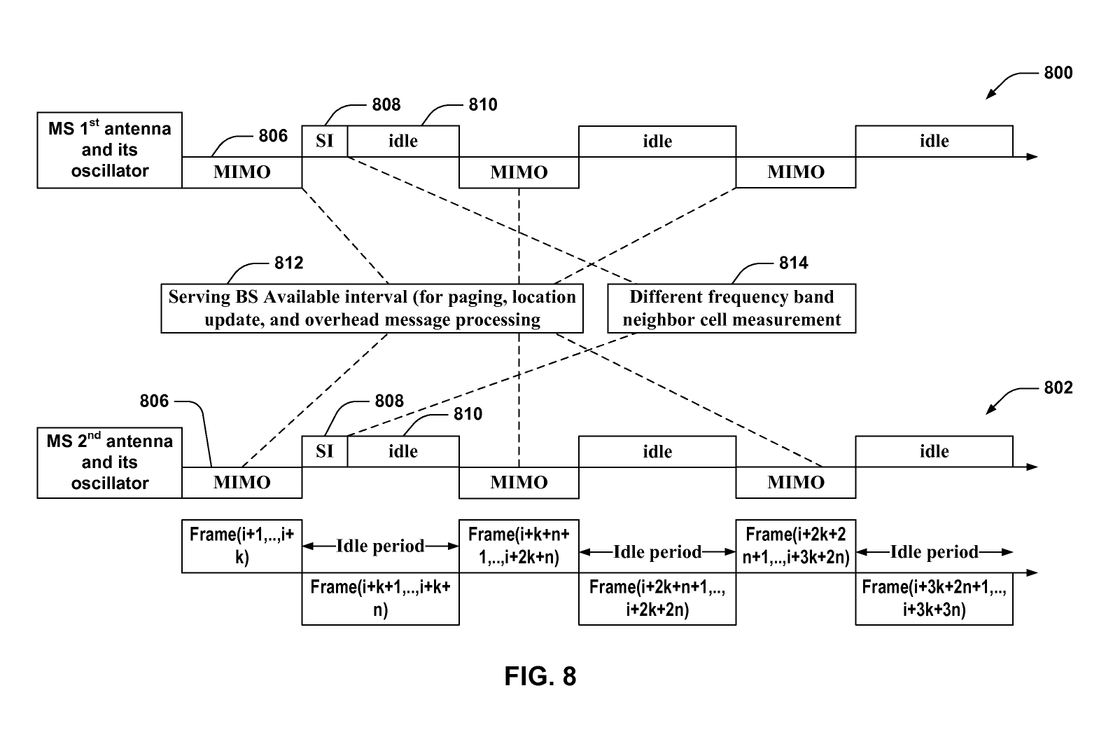

FIG. 8 illustrates example communication timelines 800 and 802 in WiMAX where idle mode unavailable time intervals can be used for performing RSSI measurements of other base stations. Timeline 800 corresponds to a first antenna at a mobile station (MS), and timeline 802 corresponds to a similar timeline for a second antenna at the MS. Timelines 800 and 802 each include alternating MIMO periods 806, SI periods 808, and/or idle 810 periods. In this example, the MS can utilize MIMO resources during the available time interval 812 for listening for signals from the source BS. Additionally, the MS can utilize a single resource for performing RSSI measurements of one or more base stations during a portion of the unavailable time interval 814 over the SI period 808. Since RSSI measurements can be performed relatively fast, the remainder of the unavailable time period 814 can be an idle period 810 where the MS does not utilize the resources. The resources used during the intervals can be defined according to a preconfiguration at the MS, a configuration received from the BS, and/or the like. For example, as described, the single resources can be assigned in periods 808 for measuring RSSI of other base stations based further on a signal quality of a source base station (e.g., where the CINR is greater or less than a DCD handover value). Moreover, it is to be appreciated that the available and unavailable time intervals can be defined according to a number of frames, as described above.

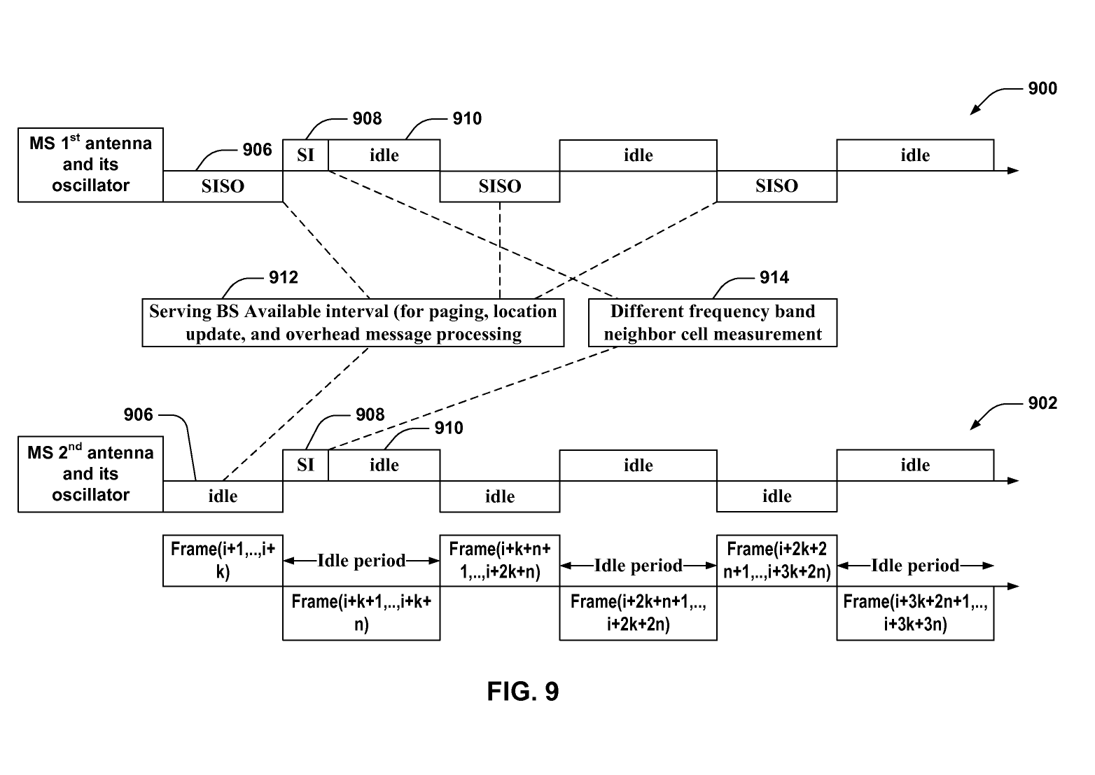

FIG. 9 illustrates example communication timelines 900 and 902 in WiMAX where idle mode unavailable time intervals can be used for performing RSSI measurements of other base stations. Timeline 900 corresponds to a first antenna at a mobile station (MS), and timeline 902 corresponds to a similar timeline for a second antenna at the MS. Timelines 900 and 902 each include alternating SISO periods 906, SI periods 908, and/or idle 910 periods. In this example, the MS can utilize SISO resources during the available time interval 912 for listening for signals from the source BS to conserve resources as compared to using MIMO in previous configurations. In one example, this can be based at least in part on determining a signal quality of the source BS (e.g., whether a CINR is greater than a DCD handover value). Additionally, the MS can utilize a single resource (e.g., a same or different resource as in SISO period 906) for performing RSSI measurements of one or more base stations during the unavailable time interval 914 over the SI period 908. Since RSSI measurements can be performed relatively fast, the remainder of the unavailable time period 914 can be an idle period 910 where MS does not utilize the resources. The resources used during the intervals can be defined according to a preconfiguration at the MS, a configuration received from the BS, and/or the like. For example, as described, the single resources can be assigned in periods 908 for measuring RSSI of other base stations based further on a signal quality of a source base station (e.g., where the CINR is greater than a DCD handover value). Moreover, it is to be appreciated that the available and unavailable time intervals can be defined according to a number of frames, as described above.

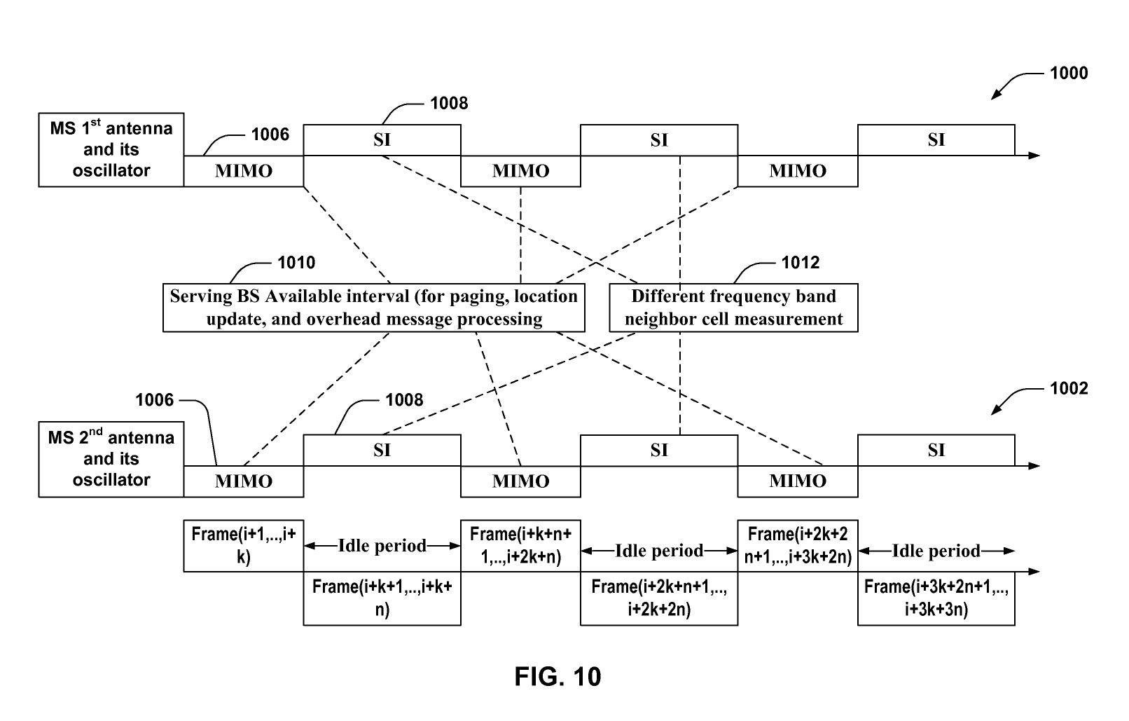

FIG. 10 illustrates example communication timelines 1000 and 1002 in WiMAX where idle mode unavailable time intervals can be used for performing CINR measurements of other base stations. Timeline 1000 corresponds to a first antenna at a mobile station (MS), and timeline 1002 corresponds to a similar timeline for a second antenna at the MS. Timelines 1000 and 1002 each include alternating MIMO periods 1006 and SI periods 1008. In this example, the MS can utilize MIMO resources during the available time interval 1010 for listening for signals from the source BS. Additionally, the MS can utilize a single resource for performing CINR measurements of one or more base stations during the unavailable time interval 1012 over the SI period 1008. Since CINR measurements can take more time than RSSI measurements shown in previous figures, a larger portion of (or the entire) unavailable time period 1012 can be reserved as the SI period 1008 used to perform the measurements. The resources used during the intervals can be defined according to a preconfiguration at the MS, a configuration received from the BS, and/or the like. For example, as described, the single resources can be assigned in periods 1008 for measuring CINR of other base stations based further on a signal quality of a source base station (e.g., where a CINR of the source base station is greater or less than a DCD handover value). Moreover, it is to be appreciated that the available and unavailable time intervals can be defined according to a number of frames, as described above.

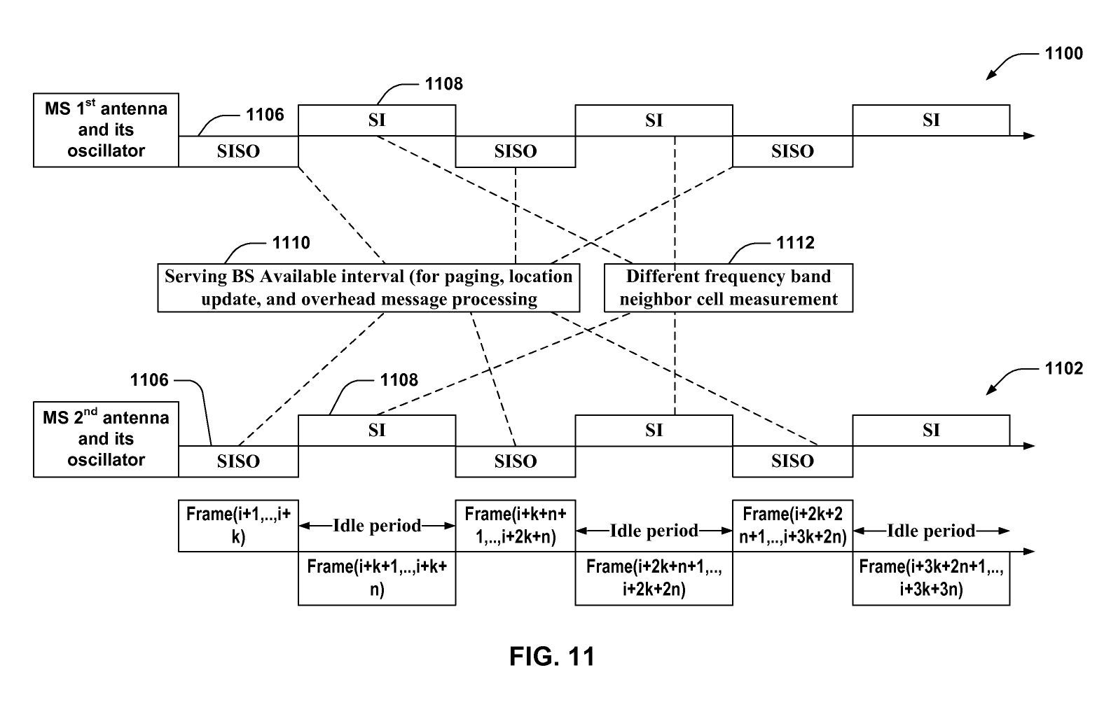

FIG. 11 illustrates example communication timelines 1100 and 1102 in WiMAX where idle mode unavailable time intervals can be used for performing CINR measurements of other base stations. Timeline 1100 corresponds to a first antenna at a mobile station (MS), and timeline 1102 corresponds to a similar timeline for a second antenna at the MS. Timelines 1100 and 1102 each include alternating SISO periods 1106 and SI periods 1108. In this example, the MS can utilize SISO resources during the available time interval 1110 for listening for signals from the source BS to conserve resources as compared to using MIMO in previous configurations. In one example, this can be based at least in part on determining a signal quality of the source BS (e.g., whether a CINR is greater than a DCD handover value). Additionally, the MS can utilize a single resource (e.g., a same or different resource as in SISO period 1106) for performing CINR measurements of one or more base stations during the unavailable time interval 1112 over the SI period 1108. The resources used during the intervals can be defined according to a preconfiguration at the MS, a configuration received from the BS, and/or the like. For example, as described, the single resources can be assigned in periods 1108 for measuring CINR of other base stations based further on a signal quality of a source base station (e.g., where a CINR of the source base station is greater than a DCD handover value). Moreover, it is to be appreciated that the available and unavailable time intervals can be defined according to a number of frames, as described above.

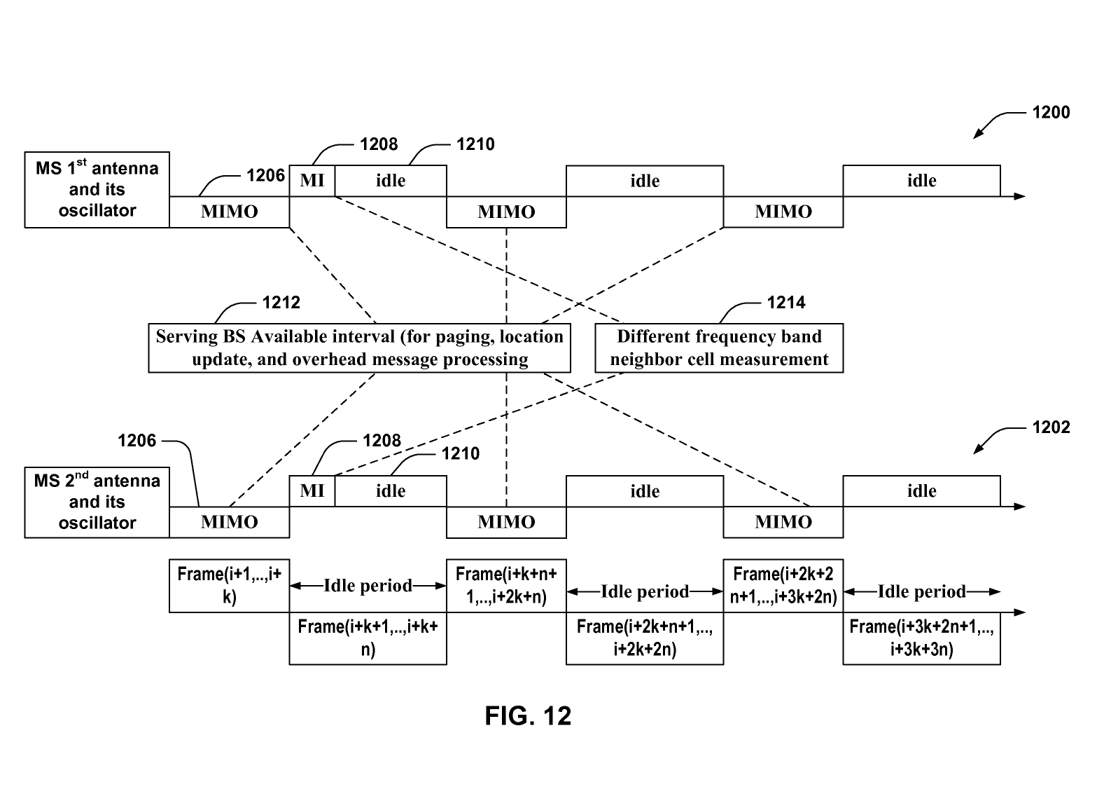

FIG. 12 illustrates example communication timelines 1200 and 1202 in WiMAX where idle mode unavailable time intervals can be used for performing RSSI measurements of other base stations. Timeline 1200 corresponds to a first antenna at a mobile station (MS), and timeline 1202 corresponds to a similar timeline for a second antenna at the MS. Timelines 1200 and 1202 each include alternating MIMO periods 1206, MI periods 1208, and/or idle 1210 periods. In this example, the MS can utilize MIMO resources during the available time interval 1212 for listening for signals from the source BS. Additionally, the MS can utilize multiple resources for performing RSSI measurements of one or more base stations during the unavailable time interval 1214 over the MI period 1208. Since RSSI measurements can be performed relatively fast, the remainder of the unavailable time period 1214 can be an idle period 1210 where MS does not utilize the resources. The resources used during the intervals can be defined according to a preconfiguration at the MS, a configuration received from the BS, and/or the like. For example, as described, the multiple resources can be assigned in periods 1208 for measuring RSSI of other base stations based further on a signal quality of a source base station (e.g., where the CINR is less than a DCD handover value). Moreover, it is to be appreciated that the available and unavailable time intervals can be defined according to a number of frames, as described above.

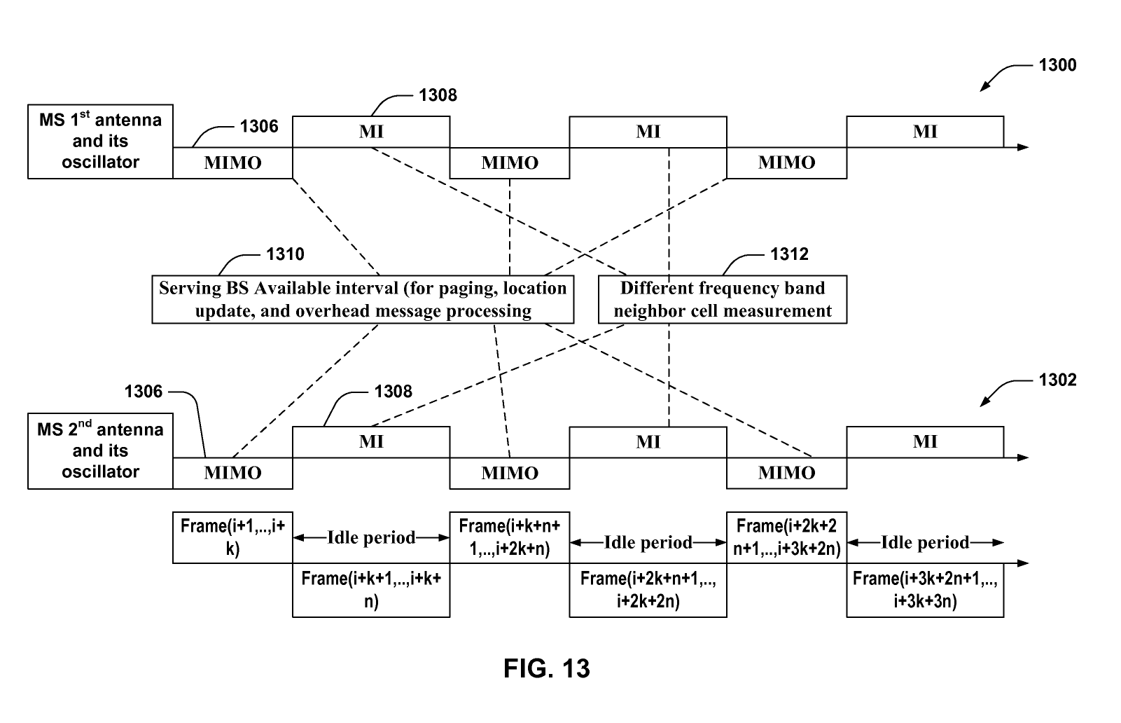

FIG. 13 illustrates example communication timelines 1300 and 1302 in WiMAX where idle mode unavailable time intervals can be used for performing CINR or other measurements of other base stations. Timeline 1300 corresponds to a first antenna at a mobile station (MS), and timeline 1302 corresponds to a similar timeline for a second antenna at the MS. Timelines 1300 and 1302 each include alternating MIMO periods 1306 and MI periods 1308. In this example, the MS can utilize MIMO resources during the available time interval 1310 for listening for signals from the source BS. Additionally, the MS can utilize multiple resources for performing CINR or other measurements of one or more base stations during the unavailable time interval 1312 over the MI period 1308. Since CINR measurements can take more time than RSSI measurements shown in previous figures, a larger portion of (or the entire) unavailable time period 1312 can be reserved as the MI period 1308 used to perform the measurements. The resources used during the intervals can be defined according to a preconfiguration at the MS, a configuration received from the BS, and/or the like. For example, as described, the multiple resources can be assigned in periods 1308 for measuring CINR of other base stations based further on a signal quality of a source base station (e.g., where a CINR of the source base station is less than a DCD handover value). Moreover, it is to be appreciated that the available and unavailable time intervals can be defined according to a number of frames, as described above.

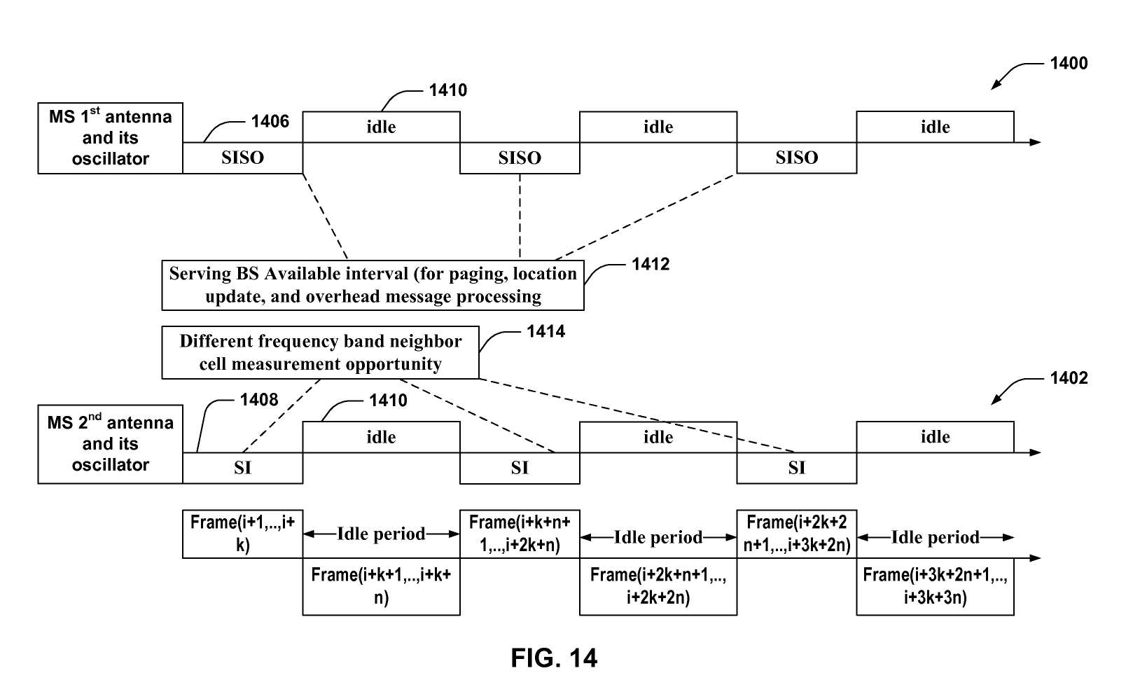

FIG. 14 illustrates example communication timelines 1400 and 1402 in WiMAX where idle mode available time intervals can be used for performing measurements of other base stations. Timeline 1400 corresponds to a first antenna at a mobile station (MS), and timeline 1402 corresponds to a similar timeline for a second antenna at the MS. Timelines 1400 and 1402 each include alternating SISO periods 1406, or SI periods 1408, and idle periods 1410. In this example, the MS can utilize SISO resources including the first antenna during the available time interval 1412 for listening for signals from the source BS. Additionally, the MS can utilize different single resources of the second antenna for performing measurements of one or more base stations during the available time interval 1414. In one example, it is to be appreciated that the SI periods 1408 can be idle in one or more time periods such that the other base stations are measured over a portion of the SI periods 1408 to conserve power. The resources used during the intervals can be defined according to a preconfiguration at the MS, a configuration received from the BS, and/or the like. For example, as described, the resources can be assigned in periods 1406 and 1408 for listening to the source base station and/or for measuring other base stations based further on a signal quality of a source base station. Moreover, it is to be appreciated that the available and unavailable time intervals can be defined according to a number of frames, as described above.

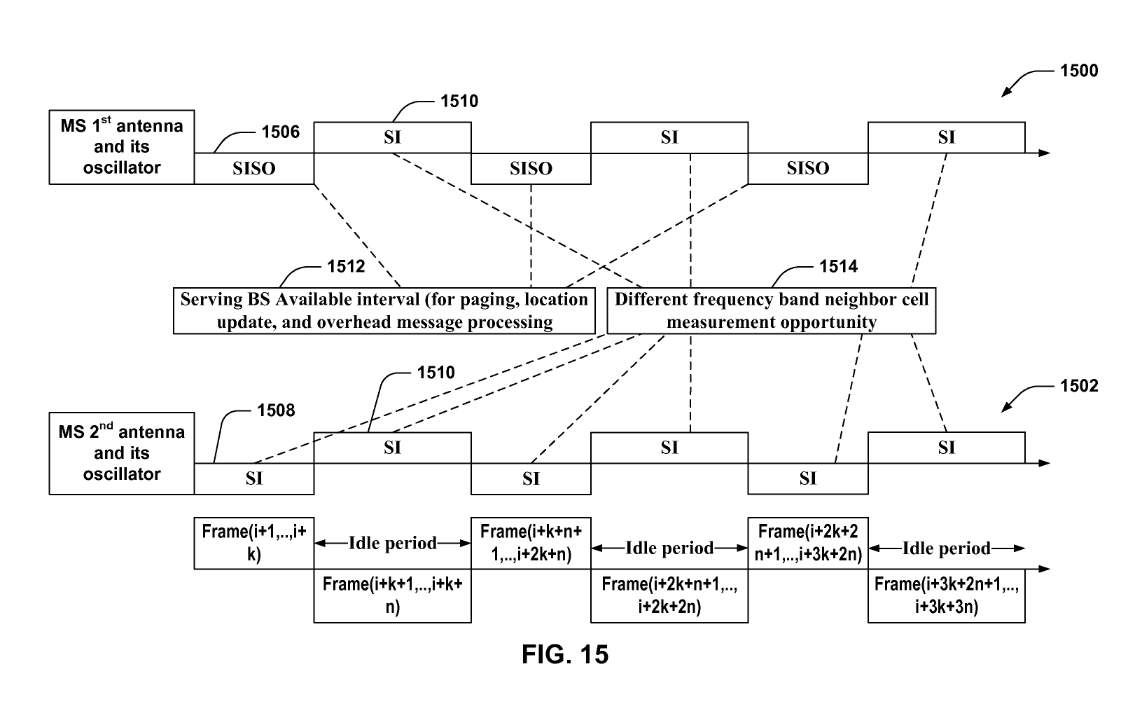

FIG. 15 illustrates example communication timelines 1500 and 1502 in WiMAX where idle mode available and/or unavailable time intervals can be used for performing measurements of other base stations. Timeline 1500 corresponds to a first antenna at a mobile station (MS), and timeline 1502 corresponds to a similar timeline for a second antenna at the MS. Timelines 1500 and 1502 each include alternating SISO periods 1506, or SI periods 1508, and additional SI periods 1510. In this example, the MS can utilize SISO resources during the available time interval 1512 for listening for signals from the source BS over the first antenna, and/or can utilize single receiving resources in SI periods 1508 of the second antenna to measure other base stations. Additionally, the MS can utilize different single resources of the first and/or second antenna for performing measurements of one or more base stations in SI periods 1510 during the unavailable time interval 1514. The resources used during the intervals can be defined according to a preconfiguration at the MS, a configuration received from the BS, and/or the like. For example, as described, the resources can be assigned in periods 1506 and 1508 for listening to the source base station and/or for measuring other base stations based further on a signal quality of a source base station. Moreover, it is to be appreciated that the available and unavailable time intervals can be defined according to a number of frames, as described above.

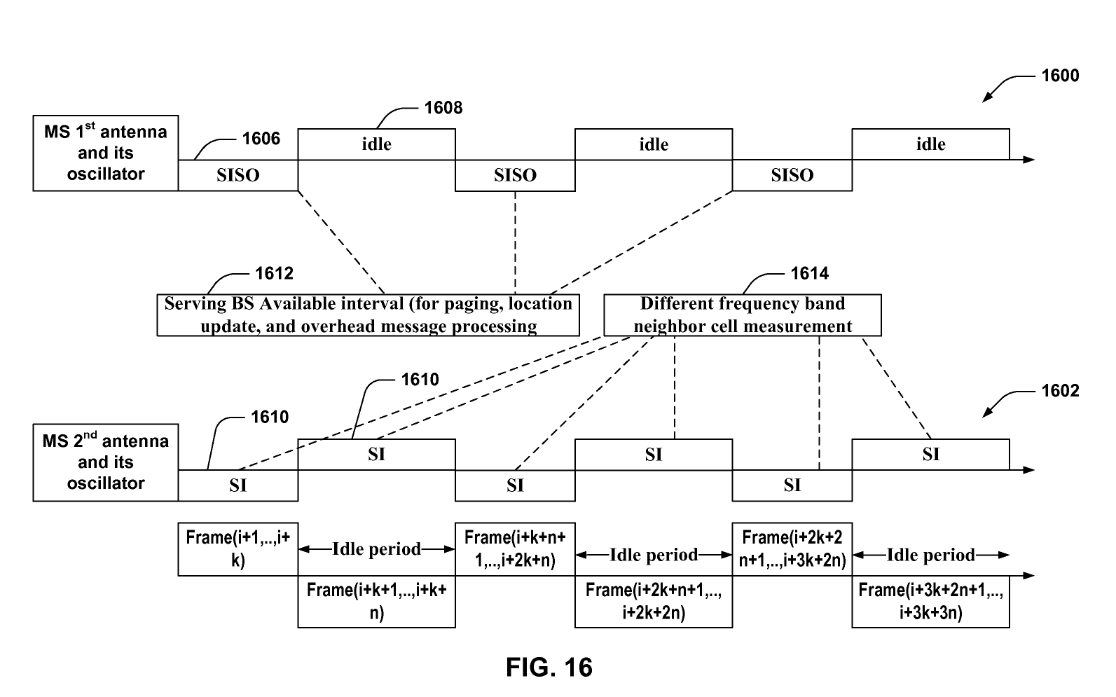

FIG. 16 illustrates example communication timelines 1600 and 1602 in WiMAX where idle mode available and/or unavailable time intervals can be used for performing measurements of other base stations. Timeline 1600 corresponds to a first antenna at a mobile station (MS), and timeline 1602 corresponds to a similar timeline for a second antenna at the MS. Timeline 1600 includes alternating SISO periods 1606, during which the MS can listen for signals from a source base station during an available time interval 1612, and idle periods 1608. Timeline 1602 includes SI periods 1610 during an available time interval 1612 and an unavailable time interval 1614, during which the MS can measure signals of other base stations. The resources used during the intervals can be defined according to a preconfiguration at the MS, a configuration received from the BS, and/or the like. For example, as described, the resources can be assigned in periods 1606 for listening to the source base station and/or for measuring other base stations in periods 1610 based further on a signal quality of a source base station. Moreover, it is to be appreciated that the available and unavailable time intervals can be defined according to a number of frames, as described above.

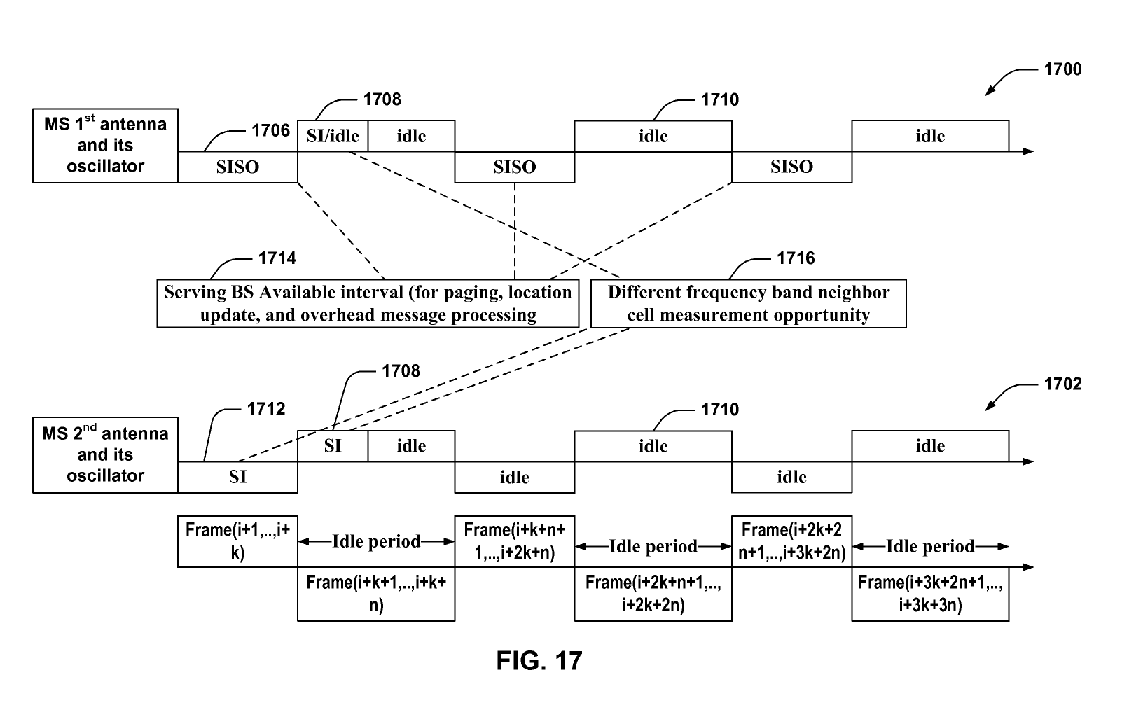

FIG. 17 illustrates example communication timelines 1700 and 1702 in WiMAX where idle mode available and/or unavailable time intervals can be used for performing measurements of other base stations. Timeline 1700 corresponds to a first antenna at a mobile station (MS), and timeline 1702 corresponds to a similar timeline for a second antenna at the MS. Timeline 1700 includes alternating SISO periods 1706, during which the MS can listen for signals from a source base station during an available time interval 1714, SI/idle periods 1708 in the unavailable time interval 1716 during which other base stations can be measured by a single resource on at least a portion of the period 1708 (e.g., an RSSI or similar measurement that is performed relatively quickly), and idle periods 1710. Timeline 1702 includes SI periods 1712 during an available time interval 1714 during which a single resource can be used to measure other base stations, as well as SI/idle periods 1708 and idle periods 1710 during an unavailable time interval 1716, as described. The resources used during the intervals can be defined according to a preconfiguration at the MS, a configuration received from the BS, and/or the like. For example, as described, the resources can be assigned in periods 1706 for listening to the source base station and/or for measuring other base stations in periods 1708 based further on a signal quality of a source base station. Moreover, it is to be appreciated that the available and unavailable time intervals can be defined according to a number of frames, as described above.

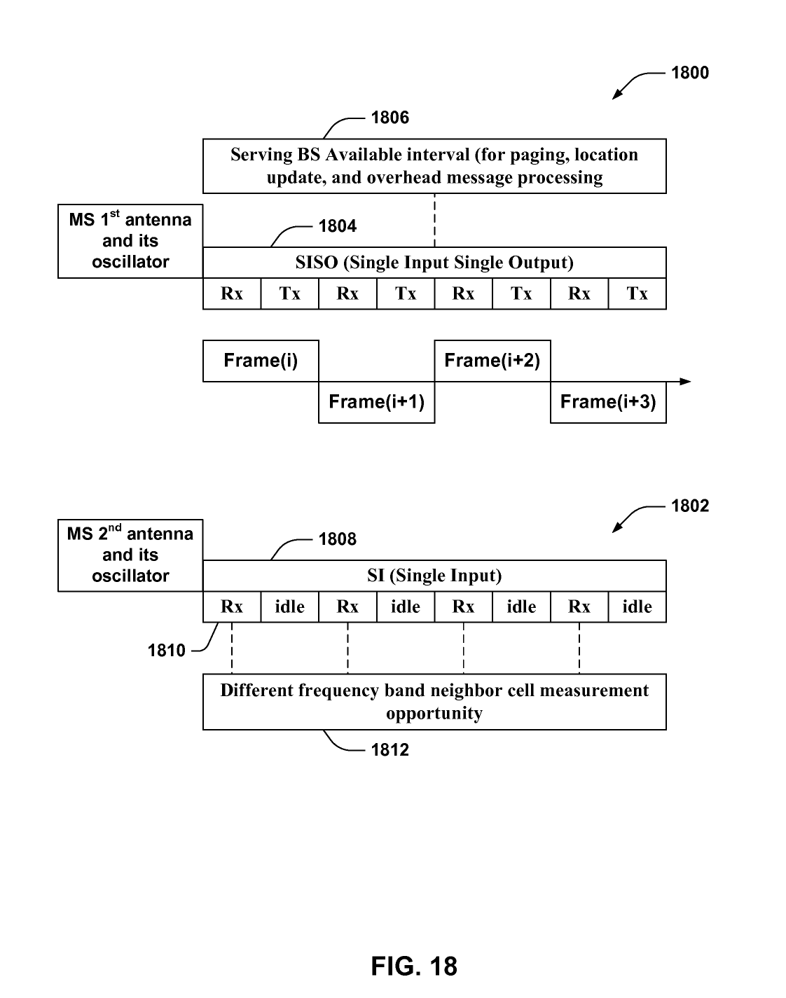

FIG. 18 illustrates example communication timelines 1800 and 1802 in WiMAX where idle mode available time intervals can be used for performing measurements of other base stations. Timeline 1800 corresponds to a first antenna at a mobile station (MS), and timeline 1802 corresponds to a similar timeline for a second antenna at the MS, both of which are over a single available time interval. In timeline 1800, the MS operates in SISO 1804 using the first antenna to receive or transmit in every other subframe. The first antenna can be used to listen for signals from the serving BS 1806 over the time interval. In timeline 1802, the second antenna can operate in SI 1808 to receive 1810 in every other subframe, while remaining idle in the remaining subframes. Thus, the second antenna can measure signals from other base stations 1812 during the receive subframes 1810 in the available time period. For example, this can be one or more RSSI measurements or other relatively quick measurements. The resources used during the subframes can be defined according to a preconfiguration at the MS, a configuration received from the BS, and/or the like. For example, as described, the resources can be assigned in subframes 1810 for measuring other base stations based further on a signal quality of a source base station.

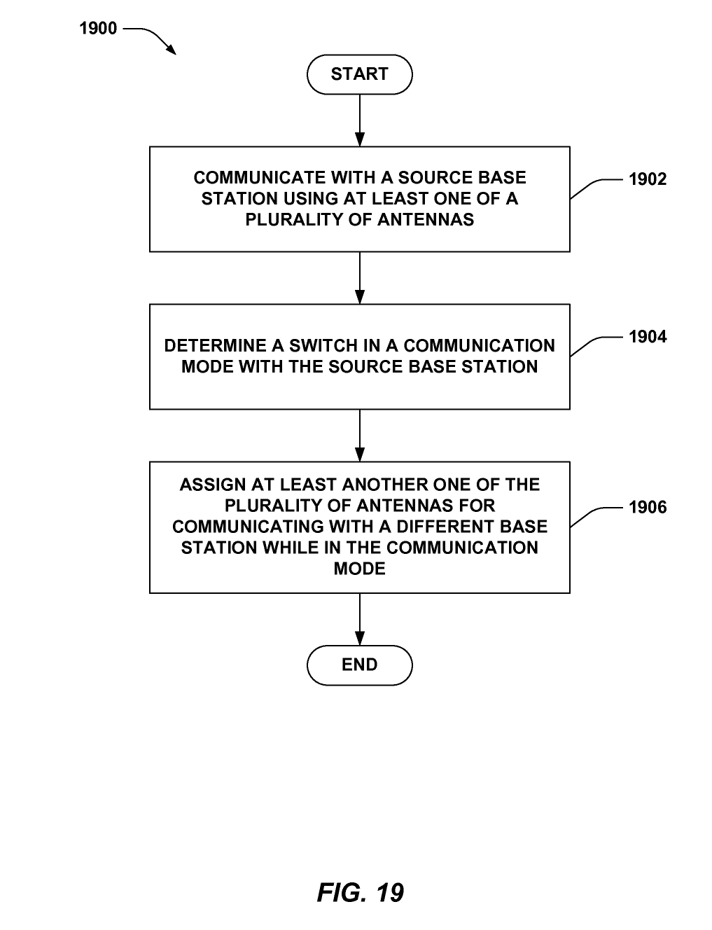

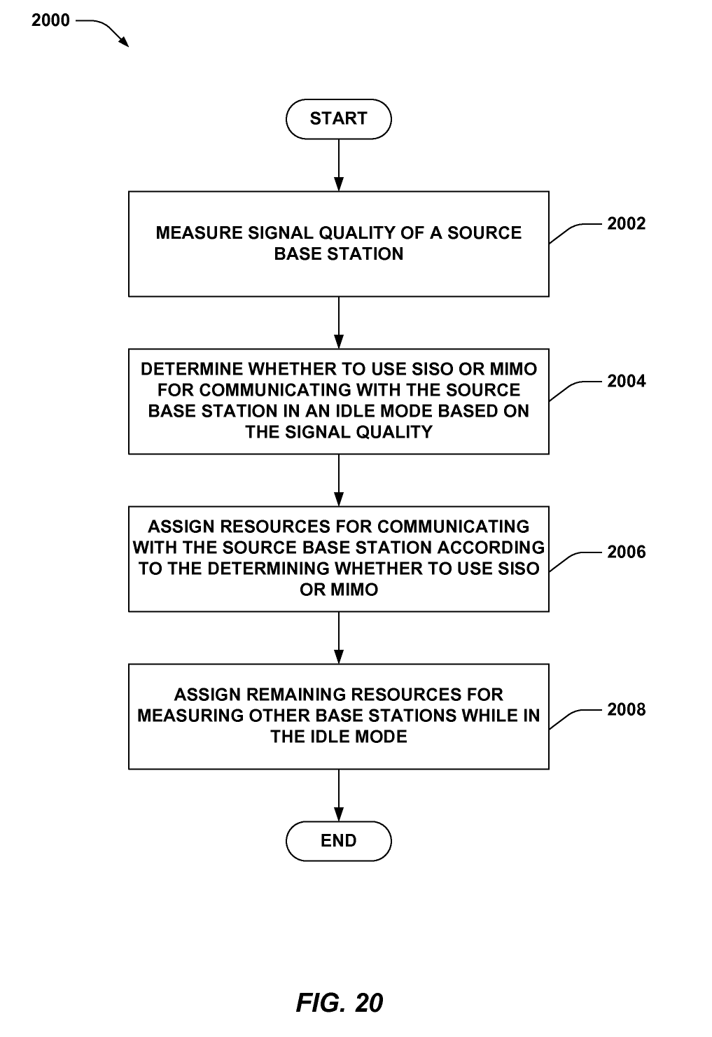

Referring to FIGS. 19-20, example methodologies relating to assigning resources in idle or sleep mode communications are illustrated. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 19, an example methodology 1900 for assigning resources for communicating with multiple base stations based on a communication mode is illustrated. At 1902, a source base station can be communicated with using at least one of a plurality of antennas. Thus, for example, the source base station can be communicated with in SISO, MIMO, etc., as described. At 1904, a switch in communication mode with the source base station can be determined. This can be based on receiving a notification from the source base station, detecting a period of inactivity in communicating with the source base station, and/or the like, and the mode can correspond to switching to an idle or sleep mode, or one or more intervals thereof (e.g., an available or unavailable time interval), etc. At 1906, at least another one of the plurality of antennas can be assigned for communicating with a different base station while in the communication mode. As described, this can include assigning one or more antennas for measuring signals from the other base station, and in one example, one or more other antennas can be reserved for receiving paging signals from the source base station. Moreover, the antennas for assigning for the multiple purposes can be based further on a signal quality of the source base station. In addition, a type of measurement for measuring the other base stations can be determined (e.g., RSSI, CINR, and/or the like).

Referring to FIG. 20, an example methodology 2000 is shown for assigning resources for communicating with a source base station and for measuring other base stations in idle or sleep mode communications. At 2002, a signal quality of a source base station can be measured. For example, this can be a CINR or other signal-to-noise ratio measurement. At 2004, it can be determined whether to use SISO or MIMO for communicating with the source base station in an idle mode based on the signal quality. In one example, where the signal quality is below a handover threshold, MIMO resources can be used for measuring other base station signals, as described above. Where the signal quality is low but not quite at the handover threshold (e.g., under a threshold level that is greater than the handover threshold), MIMO resources can be used instead to communicate with the source base station, while SISO or a smaller portion of MIMO resources can be used to measure other base stations. Where the signal quality is at least at a threshold level, in another example, at least SISO resources can be determined for communicating with the source base station. At 2006, resources for communicating with the source base station can be assigned according to the determining whether to use SISO or MIMO, and at 2008, remaining resources can be assigned for measuring other base stations while in the idle mode.

It will be appreciated that, in accordance with one or more aspects described herein, inferences can be made regarding determining whether to use MIMO or SISO to communicate with the source base station or to measure signals of other base stations, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

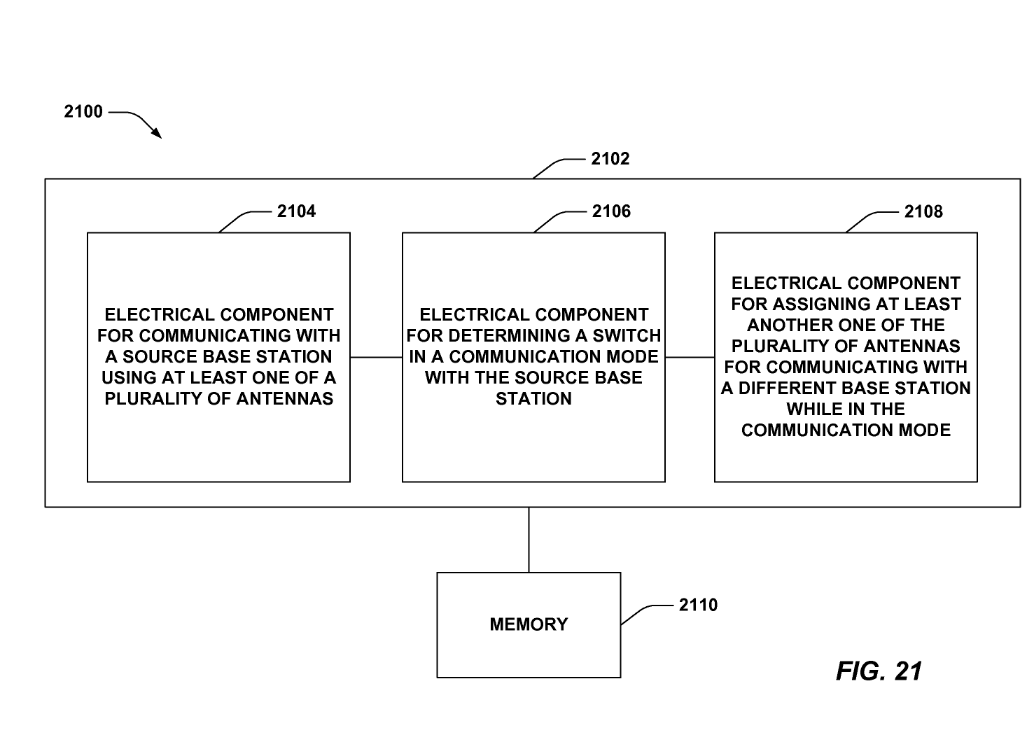

With reference to FIG. 21, illustrated is a system 2100 that assigns resources for communicating with multiple base stations in idle or sleep mode communications. For example, system 2100 can reside at least partially within a device. It is to be appreciated that system 2100 is represented as including functional blocks, which can be functional blocks that represent functions implemented by a processor, software, firmware, or combinations thereof. System 2100 includes a logical grouping 2102 of components (e.g., electrical components) that can act in conjunction. For instance, logical grouping 2102 can include an electrical component for communicating with a source base station using at least one of a plurality of antennas 2104. Further, logical grouping 2102 can comprise an electrical component for determining a switch in a communication mode with the source base station 2106. As described, for example, this can include receiving notification of the switch, detecting the switch based on inactivity (e.g., using one or more timers), and/or the like.

In addition, logical grouping 2102 can also comprise an electrical component for assigning at least another one of the plurality of antennas for communicating with a different base station while in the communication mode 2108. In an example, this can include determining whether to assign SISO or MIMO resources to each of the source base station and/or for measuring the different base station. This determination can be based on other factors as well, as described, such as signal quality of the source base station. For example, electrical component 2104 can include a transmitter 210, as described above. In addition, for example, electrical component 2106, in an aspect, can include a mode determining component 508, as described above. Moreover, electrical component 2108 can include a resource assigning component 510, for example.

Additionally, system 2100 can include a memory 2110 that retains instructions for executing functions associated with the electrical components 2104, 2106, and 2108. While shown as being external to memory 2110, it is to be understood that one or more of the electrical components 2104, 2106, and 2108 can exist within memory 2110. In one example, electrical components 2104, 2106, and 2108 can comprise at least one processor, or each electrical component 2104, 2106, and 2108 can be a corresponding module of at least one processor. Moreover, in an additional or alternative example, components 2104, 2106, and 2108 can be a computer program product comprising a computer readable medium, where each component 2104, 2106, and 2108 can be corresponding code.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for wireless communication, comprising:
communicating with a source base station using at least one of a plurality of antennas;
determining a switch in a communication mode with the source base station; and
assigning at least another one of the plurality of antennas for communicating with a different base station while in the communication mode.

2. The method of claim 1, further comprising measuring a signal quality related to the source base station.

3. The method of claim 2, further comprising:
determining whether to communicate with the source base station while in the communication mode using single-input single-output (SISO) or multiple-input multiple-output (MIMO) based at least in part on the signal quality; and
assigning a portion of the plurality of antennas for communicating with the source base station while in the communication mode based at least in part on the determining.

4. The method of claim 3, wherein the assigning at least another one of the plurality of antennas comprises assigning a remaining portion of the plurality of antennas for communicating with the different base station.

5. The method of claim 3, further comprising comparing the signal quality to a threshold level, wherein the determining whether to communicate using SISO or MIMO is based at least in part on the comparing.

6. The method of claim 5, wherein the threshold level relates to a level for causing handover from the source base station.

7. The method of claim 1, wherein the determining the switch comprises determining a start of an available time interval or an unavailable time interval in an idle mode.

8. The method of claim 1, wherein the source base station and the different base station operate using separate radio access technologies.

9. The method of claim 1, further comprising measuring signals from the different base station using the at least another one of the plurality of antennas.

10. The method of claim 9, further comprising determining a type of measurement for the measuring based at least in part on a length of the communication mode, whether the different base station operates on another frequency, or one or more power consumption parameters.

11. An apparatus for wireless communication, comprising:
at least one processor configured to:
communicate with a source base station using at least one of a plurality of antennas;
determine a switch in a communication mode with the source base station; and
assign at least another one of the plurality of antennas for communicating with a different base station while in the communication mode; and
a memory coupled to the at least one processor.

12. The apparatus of claim 11, wherein the at least one processor is further configured to measure a signal quality related to the source base station.

13. The apparatus of claim 12, wherein the at least one processor is further configured to assign a portion of the plurality of antennas for communicating with the source base station while in the communication mode based at least in part on determining whether to communicate with the source base station using single-input single-output or multiple-input multiple-output based at least in part on the signal quality.

14. The apparatus of claim 13, wherein the at least another one of the plurality of antennas comprises a remaining portion of the plurality of antennas.

15. The apparatus of claim 13, wherein the at least one processor assigns the portion of the plurality of antennas further based at least in part on comparing the signal quality to a threshold level.

16. The apparatus of claim 15, wherein the threshold level relates to a level for causing handover from the source base station.

17. The apparatus of claim 11, wherein the at least one processor determines the switch based at least in part on determining a start of an available time interval or an unavailable time interval in an idle mode.

18. The apparatus of claim 11, wherein the source base station and the different base station operate using separate radio access technologies.

19. The apparatus of claim 11, wherein the at least one processor is further configured to measure signals from the different base station using the at least another one of the plurality of antennas.

20. The apparatus of claim 19, wherein the at least one processor is further configured to determine a type of measurement for the measuring based at least in part on a length of the communication mode, whether the different base station operates on another frequency, or one or more power consumption parameters.

21. An apparatus for wireless communications, comprising:
means for communicating with a source base station using at least one of a plurality of antennas;
means for determining a switch in a communication mode with the source base station; and
means for assigning at least another one of the plurality of antennas for communicating with a different base station while in the communication mode.

22. The apparatus of claim 21, further comprising means for measuring a signal quality related to the source base station.

23. The apparatus of claim 22, wherein the means for assigning assigns a portion of the plurality of antennas for communicating with the source base station while in the communication mode based at least in part on determining whether to communicate with the source base station using single-input single-output (SISO) or multiple-input multiple-output (MIMO) based at least in part on the signal quality.

24. The apparatus of claim 23, wherein the at least another one of the plurality of antennas comprises a remaining portion of the plurality of antennas.

25. The apparatus of claim 23, further comprising means for comparing the signal quality to a threshold level, wherein the means for assigning determines whether to communicate using SISO or MIMO based at least in part on the comparing.

26. The apparatus of claim 25, wherein the threshold level relates to a level for causing handover from the source base station.

27. The apparatus of claim 21, wherein the means for determining determines the switch at least in part by determining a start of an available time interval or an unavailable time interval in an idle mode.

28. The apparatus of claim 21, wherein the source base station and the different base station operate using separate radio access technologies.

29. The apparatus of claim 21, further comprising means for measuring signals from the different base station using the at least another one of the plurality of antennas.

30. The apparatus of claim 29, wherein the means for measuring determines a type of measurement based at least in part on a length of the communication mode, whether the different base station operates on another frequency, or one or more power consumption parameters.

31. A computer program product, comprising:
a non-transitory computer-readable medium, comprising:
code for causing at least one computer to communicate with a source base station using at least one of a plurality of antennas;
code for causing the at least one computer to determine a switch in a communication mode with the source base station; and
code for causing the at least one computer to assign at least another one of the plurality of antennas for communicating with a different base station while in the communication mode.

32. The computer program product of claim 31, wherein the computer-readable medium further comprises code for causing the at least one computer to measure a signal quality related to the source base station.

33. The computer program product of claim 32, wherein the computer-readable medium further comprises code for causing the at least one computer to assign a portion of the plurality of antennas for communicating with the source base station while in the communication mode based at least in part on determining whether to communicate with the source base station using single-input single-output or multiple-input multiple-output based at least in part on the signal quality.

34. An apparatus for wireless communications, comprising:
a mode determining component for determining a switch in a communication mode with a source base station; and
a resource assigning component for assigning at least one of a plurality of antennas for communicating with a different base station while in the communication mode and keeping at least another one of the plurality of antennas reserved for communicating with the source base station while in the communication mode.

35. The apparatus of claim 34, further comprising a measuring component for measuring a signal quality related to the source base station.

36. The apparatus of claim 35, wherein the resource assigning component assigns a portion of the plurality of antennas for communicating with the source base station while in the communication mode based at least in part on determining whether to communicate with the source base station using single-input single-output (SISO) or multiple-input multiple-output (MIMO) based at least in part on the signal quality.

37. The apparatus of claim 36, wherein the at least another one of the plurality of antennas comprises a remaining portion of the plurality of antennas.

38. The apparatus of claim 36, further comprising a measurement comparing component for comparing the signal quality to a threshold level, wherein the resource assigning component determines whether to communicate using SISO or MIMO based at least in part on the comparing.

39. The apparatus of claim 38, wherein the threshold level relates to a level for causing handover from the source base station.

40. The apparatus of claim 34, wherein the mode determining component determines the switch at least in part by determining a start of an available time interval or an unavailable time interval in an idle mode.

41. The apparatus of claim 34, wherein the source base station and the different base station operate using separate radio access technologies.

42. The apparatus of claim 34, further comprising a measuring component for measuring signals from the different base station using the at least another one of the plurality of antennas.

43. The apparatus of claim 42, wherein the measuring component determines a type of measurement based at least in part on a length of the communication mode, whether the different base station operates on another frequency, or one or more power consumption parameters.
